(19) United States
(12) Patent Application Publication
(10) Pub. No.: US 2026/0176161 A1
(43) Pub. Date: Jun. 25, 2026

(54) Water Filtration and Storage Device

(71) Applicant: Callum Curry, Rico, CO (US)

(72) Inventor: Callum Curry, Rico, CO (US)

(21) Appl. No.: 19/282,204

(22) Filed: Jul. 28, 2025

Related U.S. Application Data
(60) Provisional application No. 63/738,066, filed on Dec. 23, 2024.

(51) Int. Cl. C02F 1/00; C02F 101/30

(52) U.S. Cl. CPC C02F 1/002; C02F 2101/30; C02F 2201/005; C02F 2201/006; C02F 2307/04; C02F 2307/10

(57) ABSTRACT

A water filtration and storage device is disclosed, which is a storage device and dispenser, as well as a combined water filtration system. The water filtration and storage device comprises a storage component that is configured in a rectangular shape. The storage component is made from stainless steel with vacuum seal insulation. The storage component includes a corrugated outer surface and a smooth inner surface to keep water clean. Preferably, the storage component has a five-gallon capacity. Further, the storage component comprises a screw-on water filter, a stow-away spigot, a fill cap, and a release valve. The storage component also comprises a recessed handle for easy carrying.

### CROSS-REFERENCE TO RELATED APPLICATION

The present application claims priority to, and the benefit of, U.S. Provisional Application No. 63/738,066, which was filed on Dec. 23, 2024, and is incorporated herein by reference in its entirety.

### FIELD OF THE INVENTION

The present invention relates generally to the field of water filtration and storage devices. More specifically, the present invention relates to a stainless steel storage container that is compatible with a screw-on water filter for filtering and storing water. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in water filtration and storage devices. Generally, plastics are everywhere including, without limitation, in drinking water, which may cause microplastic contamination in the body. Further, plastic bottles are not environmentally friendly. Thus, plastic contamination can be harmful to both the body and environment.

Accordingly, microplastics can be found in many places in the environment. These microplastics accumulate in the body and can cause harm. Drinking water can be a huge factor in the accumulation of microplastics in the body. Thus, there's a need for microplastic-free insulated water storage container and filter.

Accordingly, there is a demand for an improved water filtration and storage device that is anon-plastic storage device which can filter stored water. More particularly, there is a demand for a water filtration and storage device that has a corrugated outer surface and smooth inner surface to keep water clean.

Therefore, there exists a long felt need in the art for a water filtration and storage device that provides users with a non-plastic storage device to store filtered water. There is also a long felt need in the art for a water filtration and storage device that is made from stainless steel with vacuum seal insulation. Further, there is a long felt need in the art for a water filtration and storage device that is compatible with a screw-on water filter. Moreover, there is a long felt need in the art for a device that has a corrugated outer surface and a smooth inner surface to keep water clean. Further, there is a long felt need in the art for a water filtration and storage device that is a five-gallon capacity storage container with stow-away spigot and release valve. Finally, there is a long felt need in the art for a water filtration and storage device that includes a recessed handle and a fill cap on the top surface for easy carrying and filling.

The subject matter disclosed and claimed herein, in one embodiment thereof, comprises a water filtration and storage device. The device is a storage device and dispenser, as well as a combined water filtration system. The water filtration and storage device comprises a storage component that is configured in a rectangular shape. The storage component is made from stainless steel with vacuum seal insulation. The storage component includes a corrugated outer surface and a smooth inner surface to keep water clean. Preferably, the storage component has a five-gallon capacity. Further, the storage component comprises a screw-on water filter, a stow-away spigot, a fill cap, and a release valve. The storage component also comprises a recessed handle for easy carrying.

In this manner, the water filtration and storage device of the present invention accomplishes all of the forgoing objectives and provides users with a device that provides a non-plastic storage and filtration device for water. The device is a stainless steel storage container with screw-on water filter. The water filter would also be manufactured without the use of plastics.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a water filtration and storage device. The device is a storage device and dispenser, as well as a combined water filtration system. The water filtration and storage device comprises a storage component made from stainless steel. Preferably, the storage component has a five-gallon capacity. Further, the storage component comprises a screw-on water filter, a stow-away spigot, a fill cap, and a release valve. The storage component also comprises a recessed handle for easy carrying.

In one embodiment, the water filtration and storage device provides clean drinking water free of plastic contamination which can be harmful to both the body and the environment. Microplastics are everywhere, including drinking water, leading them to accumulate in the body. The water filtration and storage device is designed to clean and remove microplastics and other contaminants from water, as well as to keep the clean water cool and ready to dispense, as needed.

In one embodiment, the water filtration and storage device comprises a storage component that is configured in a rectangular shape. The storage component can be any suitable shape as is known in the art, depending on the needs and/or wants of a user. Typically, the storage component is rectangular in shape to allow for ease in storage and transportation. Thus, the shape of the storage component allows for multiple storage components to be stored side-by-side without taking up a lot of space. Further, the storage component comprises a top surface, a bottom surface, opposing front and back ends, and opposing side walls.

In one embodiment, the storage component is made from stainless steel with vacuum seal insulation. Typically, the storage component would be comprised entirely of stainless steel or other suitable materials, as long as the storage component is microplastic free. Further, the storage component includes vacuum seal insulation to keep the clean water within the storage component, cool and ready to drink.

In one embodiment, the storage component includes a corrugated outer surface and a smooth inner surface to keep the water within the storage component clean. Typically, a corrugated outer surface provides a durable, cost-effective, space-efficient, eco-friendly, and versatile solution for water storage needs. Further, the smooth inner surface allows for the hygienic storage of water or other substances within the storage component.

In one embodiment, the storage component has a five-gallon capacity. Typically, the storage component is available in a variety of sizes but has a preferred embodiment of a five-gallon capacity storage container. The storage component can be available in many different sizes depending on the needs and/or wants of a user.

In one embodiment, the storage component comprises a fill opening on the top surface, which allows a user to fill the storage component, as needed. The fill opening can be any suitable shape and size as is known in the art, depending on the needs and/or wants of a user. Typically, the fill opening is closed with a fill cap. The fill cap is sized and shaped to completely seal the fill opening and prevent water from leaking out of the storage component during use and transportation. Further, the fill cap is typically a recessed fill cap, such that once applied to the fill opening, the fill cap is flush with the top surface of the storage component and creates a flat, top surface. Typically, the fill cap is a stainless steel construction with a rubber gasket for sealing but can be manufactured of any other suitable materials as is known in the art.

In one embodiment, the fill opening is compatible with a screw-on water filter. The water filter can be any suitable water filter as is known in the art. Further, the water filter is sized and shaped to be easily screwed into the fill opening and screwed out for removal, as needed.

In one embodiment, the storage component comprises a stow-away spigot on the front end. The spigot can be any suitable spigot as is known in the art, which acts to release water or other substances from the storage component. The spigot is typically a stainless steel construction which includes a stainless steel collar and rubber gasket to prevent leaks. The spigot can be stowed away, such that it is recessed with the storage component when not in use. Then the spigot can be reversed or extended for use, allowing a user to dispense clean water from the storage component with ease.

In one embodiment, the storage component comprises a release valve. The release valve is typically positioned on the top surface of the storage component but can be located in any suitable position on the storage component as is known in the art. The release valve is typically a conventional release valve, and acts to release pressure within the storage component, as needed during use. Typically, the release valve is typically a recessed release valve, such that once the release valve is closed, the release valve is flush with the top surface of the storage component and creates a flat, top surface. Typically, the release valve is a stainless steel construction with a rubber gasket for sealing but can be manufactured of any other suitable materials as is known in the art.

In one embodiment, the storage component also comprises a flat top surface with a recessed handle for easy carrying. The recessed handle is typically an indentation or other suitable handle means as is known in the art. Typically, the handle is recessed with the top surface of the storage component and creates a flat, top surface.

In one embodiment, the water filtration and storage device is manufactured from stainless steel, titanium, aluminum, steel, plastic, fiber-reinforced plastic, or other suitable materials as is known in the art, or a combination of such materials.

In yet another embodiment, the water filtration and storage device comprises a plurality of indicia.

In yet another embodiment, a method of filtering and storing water without micro-plastics is disclosed. The method includes the steps of providing a water filtration and storage device comprising a stainless steel storage component with vacuum seal insulation. The method also comprises screwing-on the water filter to the storage component. Further, the method comprises adding water to the storage component. The method also comprises filtering the water via the water filter on the storage component. Finally, the method comprises storing the filtered water within the storage component, as needed.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the water filtration and storage device of the present invention in accordance with the disclosed architecture;

FIG. 2 illustrates a perspective view of one embodiment of the water filtration and storage device of the present invention showing the screw-on water filter in accordance with the disclosed architecture;

FIG. 3 illustrates a perspective view of one embodiment of the water filtration and storage device of the present invention showing the stow-away spigot in accordance with the disclosed architecture;

FIG. 4 illustrates a perspective view of one embodiment of the water filtration and storage device of the present invention showing the recessed handle in accordance with the disclosed architecture;

FIGS. 5A-B illustrate a perspective view of one embodiment of the water filtration and storage device of the present invention showing release valve in accordance with the disclosed architecture;

FIGS. 6A-B illustrate a perspective view of one embodiment of the water filtration and storage device of the present invention in use in accordance with the disclosed architecture; and

FIG. 7 illustrates a flowchart showing the method of filtering and storing water without micro-plastics in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a water filtration and storage device that provides users with a non-plastic storage device to store filtered water. There is also a long felt need in the art for a water filtration and storage device that is made from stainless steel with vacuum seal insulation. Further, there is a long felt need in the art for a water filtration and storage device that is compatible with a screw-on water filter. Moreover, there is a long felt need in the art for a device that has a corrugated outer surface and a smooth inner surface to keep water clean. Further, there is a long felt need in the art for a water filtration and storage device that is a five-gallon capacity storage container with stow-away spigot and release valve. Finally, there is a long felt need in the art for a water filtration and storage device that includes a recessed handle and a fill cap on the top surface for easy carrying and filling.

The present invention, in one exemplary embodiment, is a novel water filtration and storage device. The water filtration and storage device comprises a storage component that is configured in a rectangular shape. The storage component is made from stainless steel with vacuum seal insulation. The storage component includes a corrugated outer surface and a smooth inner surface to keep water clean. Preferably, the storage component has a five-gallon capacity. Further, the storage component comprises a screw-on water filter, a stow-away spigot, a fill cap, and a release valve. The storage component also comprises a recessed handle for easy carrying. The present invention also includes a novel method of filtering and storing water without micro-plastics. The method includes the steps of providing a water filtration and storage device comprising a stainless steel storage component with vacuum seal insulation. The method also comprises screwing-on the water filter to the storage component. Further, the method comprises adding water to the storage component. The method also comprises filtering the water via the water filter on the storage component. Finally, the method comprises storing the filtered water within the storage component, as needed.

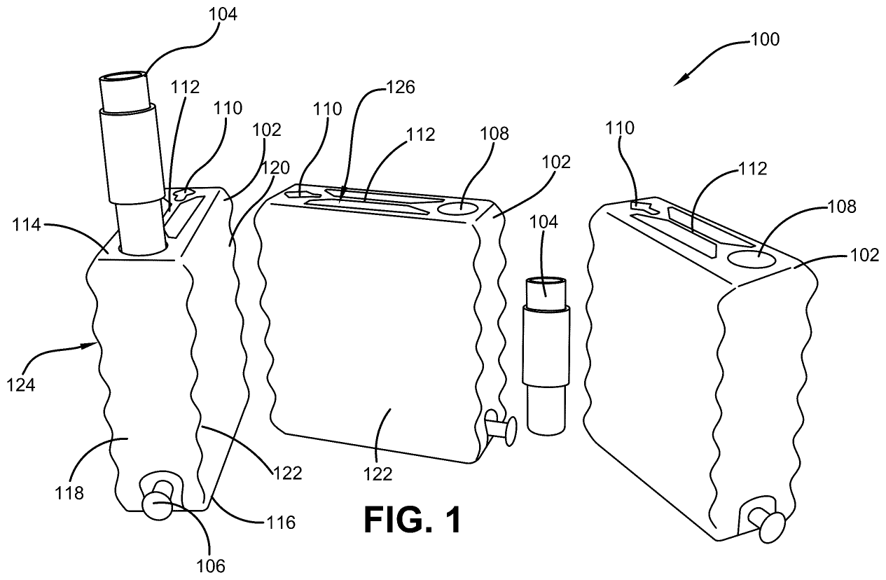

Referring initially to the drawings, FIG. 1 illustrates a perspective view of one embodiment of the water filtration and storage device 100 of the present invention. In the present embodiment, the water filtration and storage device 100 is an improved water filtration and storage device 100 that provides a user with a non-plastic mean for storing and filtering water. Specifically, the water filtration and storage device 100 comprises a stainless steel storage component 102 and an attached water filter 104. Further, the storage component 102 comprises a stow-away spigot 106, a fill cap 108, and a release valve 110. The storage component 102 also comprises a recessed handle 112 for easy carrying.

Generally, the water filtration and storage device 100 provides clean drinking water free of plastic contamination which can be harmful to both the body and the environment. Microplastics are everywhere, including drinking water, leading them to accumulate in the body. The water filtration and storage device 100 is designed to clean and remove microplastics and other contaminants from water, as well as to keep the clean water cool and ready to dispense, as needed.

Further, the water filtration and storage device 100 comprises a storage component 102 that is configured in a rectangular shape. The storage component 102 can be any suitable shape as is known in the art, depending on the needs and/or wants of a user. Typically, the storage component 102 is rectangular in shape to allow for ease in storage and transportation. Thus, the shape of the storage component 102 allows for multiple storage components 102 to be stored side-by-side without taking up a lot of space. Further, the storage component 102 comprises a top surface 114, a bottom surface 116, opposing front 118 and back 120 ends, and opposing side walls 122.

Additionally, the storage component 102 includes a corrugated outer surface 124 and a smooth inner surface 126 to keep the water within the storage component 102 clean. Typically, a corrugated outer surface 124 provides a durable, cost-effective, space-efficient, eco-friendly, and versatile solution for water storage needs. Further, the smooth inner surface 126 allows for the hygienic storage of water or other substances within the storage component 102.

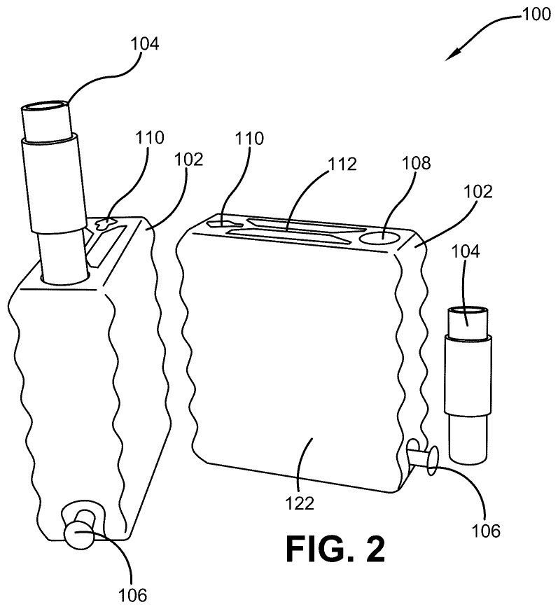

As shown in FIG. 2, the storage component 102 comprises a fill opening 200 on the top surface 114, which allows a user to fill the storage component 102, as needed. The fill opening 200 can be any suitable shape and size as is known in the art, depending on the needs and/or wants of a user. Typically, the fill opening 200 is closed with a fill cap 108. The fill cap 108 is sized and shaped to completely seal the fill opening 200 and prevent water from leaking out of the storage component 102 during use and transportation. Further, the fill cap 108 is typically a recessed fill cap, such that once applied to the fill opening 200, the fill cap 108 is flush with the top surface 114 of the storage component 102 and creates a flat, top surface 114. Typically, the fill cap 108 is a stainless steel construction with a rubber gasket for sealing but can be manufactured of any other suitable materials as is known in the art.

Further, the fill opening 200 is compatible with a screw-on water filter 104. The water filter 104 can be any suitable water filter as is known in the art. Further, the water filter 104 is sized and shaped to be easily screwed into the fill opening 200 and screwed out for removal, as needed. The water filter 104 acts to filter the water, which is then stored within the storage component 102 for use.

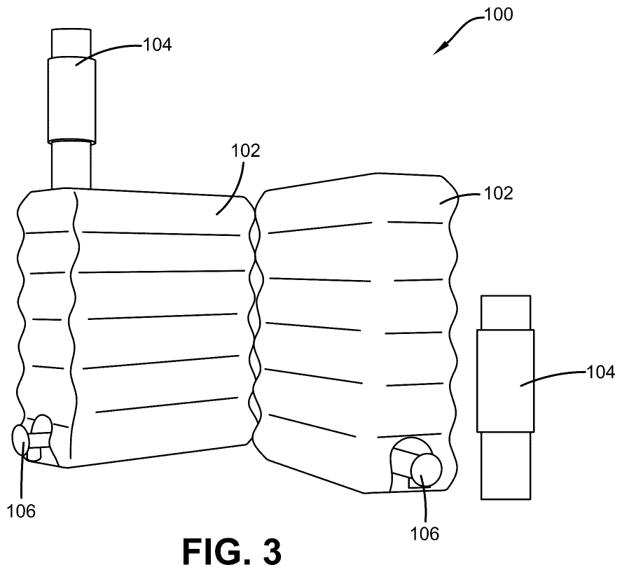

As shown in FIG. 3, the storage component 102 comprises a stow-away spigot 106 on the front end 118. The spigot 106 can be any suitable spigot as is known in the art, which acts to release water or other substances from the storage component 102. The spigot 106 is typically a stainless steel construction which includes a stainless steel collar 300 and rubber gasket 302 to prevent leaks. The spigot 106 can be stowed away, such that it is recessed with the storage component 102 when not in use. Then the spigot 106 can be reversed or extended for use, allowing a user to dispense clean water from the storage component 102 with ease.

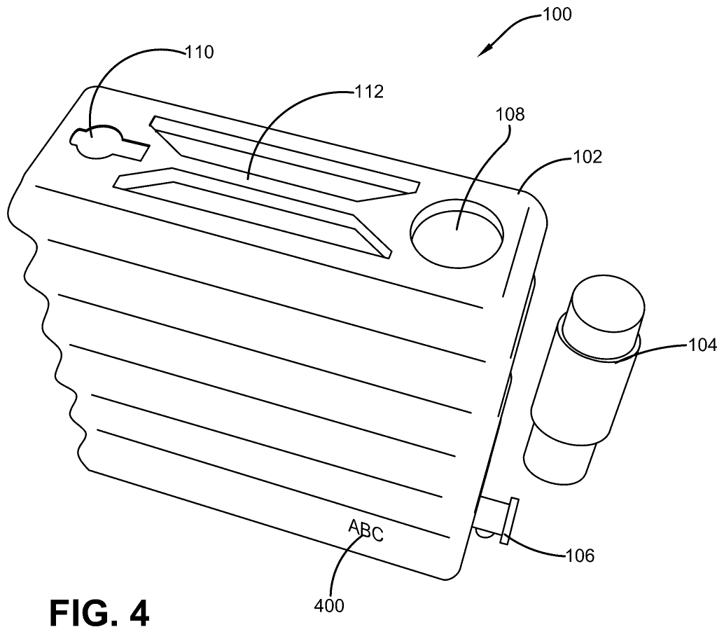

As shown in FIG. 4, the storage component 102 also comprises a flat top surface 114 with a recessed handle 112 for easy carrying. The recessed handle 112 is typically an indentation or other suitable handle means as is known in the art. Typically, the handle 112 is recessed with the top surface 114 of the storage component 102 and creates a flat, top surface 114.

In yet another embodiment, the water filtration and storage device 100 comprises a plurality of indicia 400. The storage component 102 of the device 100 may include advertising, a trademark, or other letters, designs, or characters, printed, painted, stamped, or integrated into the storage component 102, or any other indicia 400 as is known in the art. Specifically, any suitable indicia 400 as is known in the art can be included, such as but not limited to, patterns, logos, emblems, images, symbols, designs, letters, words, characters, animals, advertisements, brands, etc., that may or may not be water filtration, storage, or brand related.

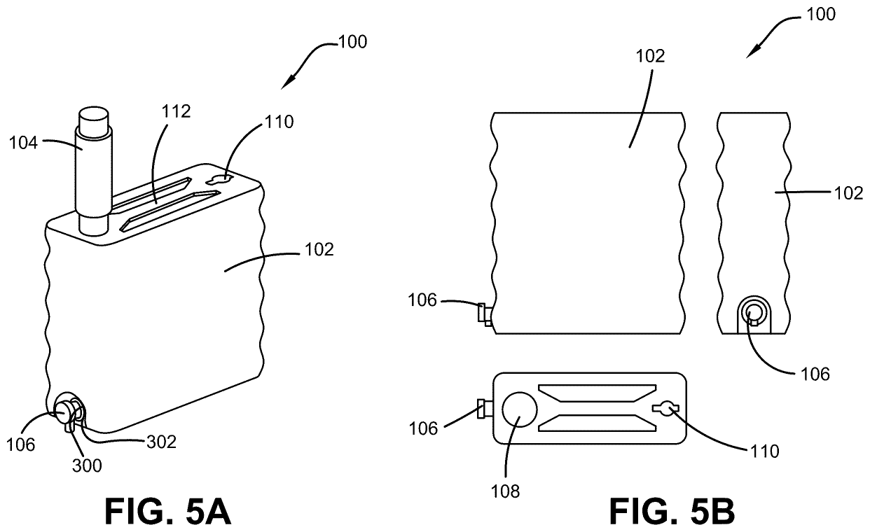

As shown in FIG. 5A-B, the storage component 102 comprises a release valve 110. The release valve 110 is typically positioned on the top surface 114 of the storage component 102 but can be located in any suitable position on the storage component 102 as is known in the art. The release valve 110 is typically a conventional release valve and acts to release pressure within the storage component 102, as needed during use. Typically, the release valve 110 is typically a recessed release valve 110, such that once the release valve 110 is closed, the release valve 110 is flush with the top surface 114 of the storage component 102 and creates a flat, top surface 114. Typically, the release valve 110 is a stainless steel construction with a rubber gasket for sealing but can be manufactured of any other suitable materials as is known in the art.

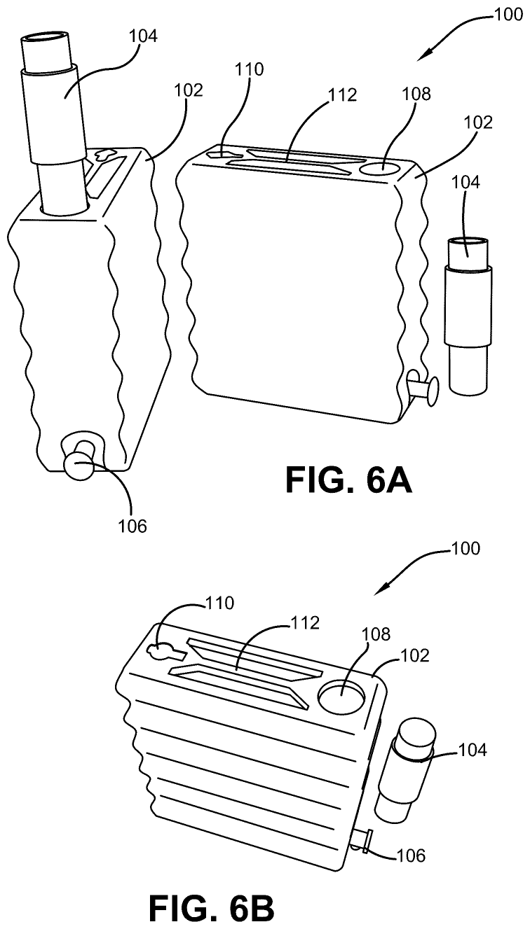

As shown in FIGS. 6A-B, the storage component 102 is made from stainless steel with vacuum seal insulation. Typically, the storage component 102 would be comprised entirely of stainless steel or other suitable materials, as long as the storage component 102 is microplastic free. Further, the storage component 102 includes vacuum seal insulation to keep the clean water within the storage component 102, cool and ready to drink.

Further, the storage component 102 has a five-gallon capacity. Typically, the storage component 102 is available in a variety of sizes but has a preferred embodiment of a five-gallon capacity storage container 102. The storage component 102 can be available in many different sizes depending on the needs and/or wants of a user.

Additionally, the water filtration and storage device 100 is manufactured from stainless steel, titanium, aluminum, or other suitable antimicrobial materials as is known in the art, or a combination of such materials.

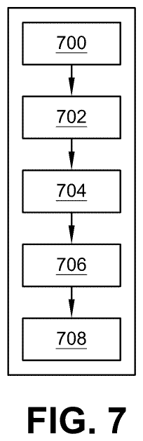

FIG. 7 illustrates a flowchart of the method of filtering and storing water without micro-plastics. The method includes the steps of at 700, providing a water filtration and storage device comprising a stainless steel storage component with vacuum seal insulation. The method also comprises at 702, screwing-on the water filter to the storage component. Further, the method comprises at 704, adding water to the storage component. The method also comprises at 706, filtering the water via the water filter on the storage component. Finally, the method comprises at 708, storing the filtered water within the storage component, as needed.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “water filtration and storage device”, “water filtration device”, “storage device”, and “device” are interchangeable and refer to the water filtration and storage device 100 of the present invention.

Notwithstanding the forgoing, the water filtration and storage device 100 of the present invention can be of any suitable size and configuration as is known in the art without affecting the overall concept of the invention, provided that it accomplishes the above stated objectives. One of ordinary skill in the art will appreciate that the water filtration and storage device 100 as shown in FIGS. 1-7 is for illustrative purposes only, and that many other sizes and shapes of the water filtration and storage device 100 are well within the scope of the present disclosure. Although the dimensions of the water filtration and storage device 100 are important design parameters for user convenience, the water filtration and storage device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A water filtration and storage device that provides a user with a non-plastic means for storing and filtering water, the water filtration and storage device comprising:
a storage component; and
a water filter;
wherein the water filter is attached to the storage component to filter water; and
further wherein the storage component and attached water filter clean and remove microplastics and other contaminants from water, as well as keep clean water cool and ready to dispense.

2. The water filtration and storage device of claim 1, wherein the storage component is configured in a rectangular shape.

3. The water filtration and storage device of claim 2, wherein the storage component comprises a top surface, a bottom surface, opposing front and back ends, and opposing side walls.

4. The water filtration and storage device of claim 3, wherein the storage component includes a corrugated outer surface and a smooth inner surface to keep water within the storage component clean.

5. The water filtration and storage device of claim 4, wherein the storage component comprises a fill opening on the top surface, which allows a user to fill the storage component, as needed.

6. The water filtration and storage device of claim 5, wherein the fill opening is closed with a fill cap.

7. The water filtration and storage device of claim 6, wherein the fill cap is typically a recessed fill cap, such that once applied to the fill opening, the fill cap is flush with the top surface of the storage component and creates a flat, top surface.

8. The water filtration and storage device of claim 7, wherein the fill opening is compatible with a screw-on water filter, that is easily screwed into the fill opening and screwed out for removal, as needed.

9. The water filtration and storage device of claim 8, wherein the storage component comprises a stow-away spigot on the front end.

10. The water filtration and storage device of claim 9, wherein the stow-away spigot can be stowed away, such that it is recessed with the storage component when not in use, then the stow-away spigot can be reversed or extended for use, allowing a user to dispense clean water from the storage component with ease.

11. The water filtration and storage device of claim 10, wherein the storage component comprises a flat top surface with a recessed handle for easy carrying.

12. The water filtration and storage device of claim 11 further comprising a plurality of indicia.

13. The water filtration and storage device of claim 12, wherein the storage component comprises a release valve.

14. The water filtration and storage device of claim 13, wherein the release valve is recessed when closed, such that the release valve is flush with the top surface of the storage component.

15. The water filtration and storage device of claim 14, wherein the storage component is made from stainless steel with vacuum seal insulation.

16. A water filtration and storage device that provides a user with a non-plastic means for storing and filtering water, the water filtration and storage device comprising:
a storage component configured in a rectangular shape comprising a top surface, a bottom surface, opposing front and back ends, and opposing side walls; and
a screw-on water filter;
wherein the screw-on water filter is easily screwed into and out of a fill opening of the storage component;
wherein the storage component includes a corrugated outer surface and a smooth inner surface to keep water within the storage component clean;
wherein the storage component comprises a fill opening on the top surface, which is closed with a fill cap;
wherein the storage component comprises a stow-away spigot on the front end, such that it is recessed with the storage component when not in use, then the stow-away spigot can be reversed or extended for use, allowing a user to dispense clean water from the storage component with ease;
wherein the storage component comprises a flat top surface with a recessed handle for easy carrying;
wherein the storage component comprises a recessed release valve on the top surface; and
further wherein the storage component and attached water filter clean and remove microplastics and other contaminants from water, as well as keep clean water cool and ready to dispense.

17. The water filtration and storage device of claim 16, wherein the storage component has a five-gallon capacity.

18. The water filtration and storage device of claim 16, wherein the storage component is available in a variety of sizes.

19. The water filtration and storage device of claim 16, wherein the water filtration and storage device and its components are all manufactured from stainless steel.

20. A method of filtering and storing water without micro-plastics, the method comprising the following steps:
providing a water filtration and storage device comprising a stainless steel storage component with vacuum seal insulation;
screwing-on the water filter to the storage component;
adding water to the storage component;
filtering the water via the water filter on the storage component; and
storing the filtered water within the storage component, as needed.
